(19) United States
(12) Patent Application Publication
(10) Pub. No.: US 2026/0120672 A1
(43) Pub. Date: Apr. 30, 2026

(54) ELECTRONIC APPARATUS FOR PERFORMING ACTIVE NOISE CANCELLATION AND CONTROLLING METHOD THEREOF

(71) Applicant: Samsung Electronics Co., Ltd., Suwon-si (KR)

(72) Inventors: Pawel DANILUK, Warszawa (PL); Mateusz LITWIN, Warszawa (PL); Jakub TKACZUK, Warszawa (PL); Hangil MOON, Suwon-si (KR); Jaemo YANG, Suwon-si (KR)

(21) Appl. No.: 19/003,182

(22) Filed: Dec. 27, 2024

Related U.S. Application Data
(63) Continuation of application No. PCT/KR2024/016700, filed on Oct. 29, 2024.

(30) Foreign Application Priority Data
Dec. 29, 2023 (KR) 10-2023-0196845

(51) Int. Cl. G10K 11/178; H04R 1/10

(52) U.S. Cl. CPC G10K 11/17881; G10K 11/17825; H04R 1/1083

(57) ABSTRACT

An electronic apparatus is provided. The electronic apparatus includes a speaker, a first microphone, a second microphone, memory storing one or more computer programs, and one or more processors communicatively coupled to the speaker, the first microphone, the second microphone, and the memory, wherein the one or more computer programs include computer-executable instructions that, when executed by the one or more processors individually or collectively, cause the electronic apparatus to control an external speaker to output sound of a first frequency, obtain a first sound signal corresponding to the sound of the first frequency through the first microphone, and obtain a second sound signal including the first sound signal through the second microphone, obtain a first noise cancelling signal based on the first sound signal and the second sound signal, output a second noise cancelling signal in which at least one of a phase or a gain of the first noise cancelling signal is changed and a third sound signal of a second frequency through the speaker, obtain the second sound signal by changing at least one of the phase or the gain, and identify at least one of a target phase or a target gain based on a third frequency component related to distortion product otoacoustic emissions (DPOAE) of the first frequency and the second frequency included in the second sound signal.

### CROSS-REFERENCE TO RELATED APPLICATION(S)

This application is a continuation application, claiming priority under §365(c), of an International application No. PCT/KR2024/016700, filed on Oct. 29, 2024, which is based on and claims the benefit of a Korean patent application number 10-2023-0196845, filed on Dec. 29, 2023, in the Korean Intellectual Property Office, the disclosure of which is incorporated by reference herein in its entirety.

### TECHNICAL FIELD

The disclosure relates to an electronic apparatus and a controlling method thereof. More particularly, the disclosure relates to an electronic apparatus that performs active noise cancellation and a controlling method thereof.

### BACKGROUND ART

With the development of electronic technology, electronic apparatuses that provide various functions are being developed. In particular, earphones with various functions, such as augmented listening, head tracking, audio recognition, spatial sound, or the like, have been popularized in recent years.

More particularly, recent earphones are becoming more user-friendly by blocking out external noise through noise cancellation.

The above information is presented as background information only to assist with an understanding of the disclosure. No determination has been made, and no assertion is made, as to whether any of the above might be applicable as prior art with regard to the disclosure.

### DETAILED DESCRIPTION OF THE DISCLOSURE

### Technical Solution

Aspects of the disclosure are to address at least the above-mentioned problems and/or disadvantages and to provide at least the advantages described below. Accordingly, an aspect of the disclosure is to provide an electronic apparatus that performs active noise cancellation and a controlling method thereof.

Additional aspects will be set forth in part in the description which follows and, in part, will be apparent from the description, or may be learned by practice of the presented embodiments.

In accordance with an aspect of the disclosure, an electronic apparatus is provided. The electronic apparatus including a speaker, a first microphone, a second microphone, memory storing one or more computer programs, and one or more processors communicatively coupled to the speaker, the first microphone, the second microphone, and the memory, wherein the one or more computer programs include computer-executable instructions that, when executed by the one or more processors individually or collectively, cause the electronic apparatus to control an external speaker to output sound of a first frequency, obtain a first sound signal corresponding to the sound of the first frequency through the first microphone, and obtain a second sound signal including the first sound signal through the second microphone, obtain a first noise cancelling signal based on the first sound signal and the second sound signal, output a second noise cancelling signal in which at least one of a phase or a gain of the first noise cancelling signal is changed and a third sound signal of a second frequency through the speaker, obtain the second sound signal by changing at least one of the phase or the gain, and identify at least one of a target phase or a target gain based on a third frequency component related to distortion product otoacoustic emissions (DPOAE) of the first frequency and the second frequency included in the second sound signal.

The one or more computer programs further include computer-executable instructions that, when executed by the one or more processors individually or collectively, cause the electronic apparatus to identify a phase section in which the phase is gradually changed such that the distortion product otoacoustic emissions (DPOAE) does not occur, and identify the target phase based on the phase section.

The one or more computer programs further include computer-executable instructions that, when executed by the one or more processors individually or collectively, cause the electronic apparatus to identify a center of the phase section as the target phase.

The one or more computer programs further include computer-executable instructions that, when executed by the one or more processors individually or collectively, cause the electronic apparatus to, based on the gain being 0, identify a minimum amplitude at which the distortion product otoacoustic emissions (DPOAE) occurs by changing an amplitude of the sound of the first frequency, and identify the target gain based on the minimum amplitude.

The one or more computer programs further include computer-executable instructions that, when executed by the one or more processors individually or collectively, cause the electronic apparatus to identify a half value of the minimum amplitude as an amplitude of the sound of the first frequency, based on the amplitude of the sound of the first frequency being the half value of the minimum amplitude, identify a minimum gain in which the distortion product otoacoustic emissions (DPOAE) occurs by changing the gain, and identify the minimum gain as the target gain.

The one or more computer programs further include computer-executable instructions that, when executed by the one or more processors individually or collectively, cause the electronic apparatus to change the first frequency and the second frequency, and repeat the target phase identification operation and the target gain identification operation, and map a plurality of target phases and a plurality of target gains obtained through the repetitive operation to corresponding first frequency and second frequency and store the same in the memory.

The one or more computer programs further include computer-executable instructions that, when executed by the one or more processors individually or collectively, cause the electronic apparatus to obtain an external sound signal corresponding to external sound through the first microphone, and obtain a fourth sound signal including the external sound signal through the second microphone, obtain a third noise cancelling signal by cancelling active noise from the external sound signal and the fourth sound signal, and output a fourth noise cancelling signal in which a phase and a gain of the third noise cancelling signal are changed based on a target phase and a target gain corresponding to a frequency of the external sound among information stored in the memory.

The one or more computer programs further include computer-executable instructions that, when executed by the one or more processors individually or collectively, cause the electronic apparatus to control a communication interface to transmit a control signal to output the sound of the first frequency to the external speaker.

The one or more computer programs further include computer-executable instructions that, when executed by the one or more processors individually or collectively, cause the electronic apparatus to receive the first sound signal, the second noise cancelling signal, the third sound signal, and the second sound signal including a sound signal corresponding to the third frequency component through the second microphone.

The one or more computer programs further include computer-executable instructions that, when executed by the one or more processors individually or collectively, cause the electronic apparatus to obtain an inverse phase signal of a signal including the first sound signal and the second sound signal as the first noise cancelling signal.

In accordance with another aspect of the disclosure, a method of controlling an electronic apparatus is provided. The method includes controlling an external speaker to output sound of a first frequency, obtaining a first sound signal corresponding to the sound of the first frequency through a first microphone of the electronic apparatus, and obtaining a second sound signal including the first sound signal through a second microphone of the electronic apparatus, obtaining a first noise cancelling signal based on the first sound signal and the second sound signal, outputting a second noise cancelling signal in which at least one of a phase or a gain of the first noise cancelling signal is changed and a third sound signal of a second frequency through a speaker of the electronic apparatus, obtaining the second sound signal by changing at least one of the phase or the gain, and identifying at least one of a target phase or a target gain based on a third frequency component related to distortion product otoacoustic emissions (DPOAE) of the first frequency and the second frequency included in the second sound signal.

The identifying includes identifying a phase section in which the phase is gradually changed such that the distortion product otoacoustic emissions (DPOAE) does not occur, and identifying the target phase based on the phase section.

The identifying includes identifying a center of the phase section as the target phase.

The identifying includes, based on the gain being 0, identifying a minimum amplitude at which the distortion product otoacoustic emissions (DPOAE) occurs by changing an amplitude of the sound of the first frequency, and identifying the target gain based on the minimum amplitude.

The identifying includes identifying a half value of the minimum amplitude as an amplitude of the sound of the first frequency, based on the amplitude of the sound of the first frequency being the half value of the minimum amplitude, identifying a minimum gain in which the distortion product otoacoustic emissions (DPOAE) occurs by changing the gain, and identifying the minimum gain as the target gain.

The method further includes changing the first frequency and the second frequency, and repeating the target phase identification operation and the target gain identification operation, and mapping a plurality of target phases and a plurality of target gains obtained through the repetitive operation to corresponding first frequency and second frequency and storing the same in memory of the electronic apparatus.

The method further includes obtaining an external sound signal corresponding to external sound through the first microphone, and obtaining a fourth sound signal including the external sound signal through the second microphone, obtaining a third noise cancelling signal by cancelling active noise from the external sound signal and the fourth sound signal, and outputting a fourth noise cancelling signal in which a phase and a gain of the third noise cancelling signal are changed based on a target phase and a target gain corresponding to a frequency of the external sound among information stored in the memory.

The controlling includes transmitting a control signal to output the sound of the first frequency to the external speaker.

The obtaining the first sound signal and the second sound signal includes receiving the first sound signal, the second noise cancelling signal, the third sound signal, and the second sound signal including a sound signal corresponding to the third frequency component through the second microphone.

The obtaining the first noise cancelling signal includes obtaining an inverse phase signal of a signal including the first sound signal and the second sound signal as the first noise cancelling signal.

In accordance with an aspect of the disclosure, one or more non-transitory computer-readable storage media storing computer-executable instructions that, when executed by one or more processors individually or collectively, cause an electronic apparatus to perform operations are provided. The operations include controlling an external speaker to output sound of a first frequency, obtaining a first sound signal corresponding to the sound of the first frequency through a first microphone of the electronic apparatus, and obtaining a second sound signal including the first sound signal through a second microphone of the electronic apparatus, obtaining a first noise cancelling signal based on the first sound signal and the second sound signal, outputting a second noise cancelling signal in which at least one of a phase or a gain of the first noise cancelling signal is changed and a third sound signal of a second frequency through a speaker of the electronic apparatus, obtaining the second sound signal by changing at least one of the phase or the gain, and identifying at least one of a target phase or a target gain based on a third frequency component related to distortion product otoacoustic emissions (DPOAE) of the first frequency and the second frequency included in the second sound signal.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF DRAWINGS

The above and other aspects, features, and advantages of certain embodiments of the disclosure will be more apparent from the following description taken in conjunction with the accompanying drawings, in which:

FIGS. 1A, 1B, and 1C are views provided to illustrate noise cancellation to help understanding according to various embodiments of the disclosure;

FIG. 2 is a block diagram illustrating configuration of an electronic apparatus according to an embodiment of the disclosure;

FIG. 3 is a block diagram illustrating detailed configuration of an electronic apparatus according to an embodiment of the disclosure;

FIG. 4 is a view provided to illustrate distortion product otoacoustic emissions (DPOAE) according to an embodiment of the disclosure;

FIGS. 5 and 6 are views provided to illustrate noise cancellation according to various embodiments of the disclosure;

FIG. 7 is a view provided to illustrate a method of identifying a target phase according to an embodiment of the disclosure;

FIG. 8 is a view provided to illustrate a method of identifying a target gain according to an embodiment of the disclosure;

FIGS. 9, 10, 11, and 12 are views provided to illustrate an effect of noise cancellation according to various embodiments of the disclosure; and

FIG. 13 is a flowchart provided to illustrate a controlling method of an electronic apparatus according to an embodiment of the disclosure.

Throughout the drawings, it should be noted that like reference numbers are used to depict the same or similar elements, features, and structures.

### DETAILED DESCRIPTION OF EMBODIMENTS

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The disclosure is to provide an electronic apparatus for performing noise cancellation with a user's ear membrane as a reference location and a controlling method thereof.

Hereinafter, the disclosure will be described with reference to accompanying drawings.

General terms that are currently widely used are selected as the terms used in the embodiments of the disclosure based on their functions in the disclosure, but may be changed based on the intention of those skilled in the art or a judicial precedent, the emergence of a new technique, or the like. In addition, in a specific case, terms arbitrarily chosen by an applicant may exist. In this case, the meanings of such terms are mentioned in the corresponding descriptions of the disclosure. Therefore, the terms used in the embodiments of the disclosure need to be defined based on the meanings of the terms and the overall contents throughout the disclosure rather than simple names of the terms.

In the disclosure, an expression “have”, “may have”, “include”, “may include” or the like, indicates the existence of a corresponding feature (e.g., a numerical value, a function, an operation or a component, such as a part), and does not exclude the existence of an additional feature.

An expression, “at least one of A or/and B” should be understood as indicating any one of “A”, “B” and “both of A and B.”

Expressions “1st”, “2nd”, “first”, “second”, and the like, used in the disclosure may indicate various components regardless of the sequence and/or importance of the components, and these expressions are used only to distinguish one component from another component, and do not limit the corresponding components.

It is to be understood that a term “include”, “formed of”, or the like used in the application specifies the presence of features, numerals, steps, operations, components, parts, or combinations thereof, mentioned in the specification, and does not preclude the presence or addition of one or more other features, numerals, steps, operations, components, parts, or combinations thereof.

In this specification, a term ‘user’ may refer to a person using an electronic apparatus or a device using an electronic apparatus (e.g., an artificial intelligence electronic apparatus).

Hereinafter, various embodiments of the disclosure will be described with reference to the accompanying drawings.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

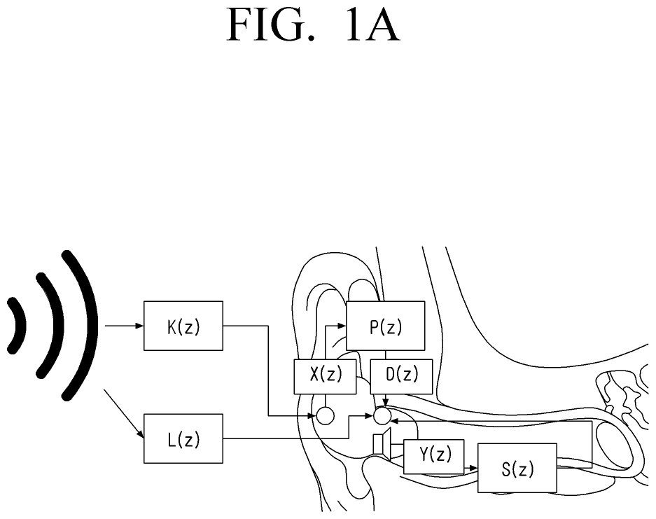

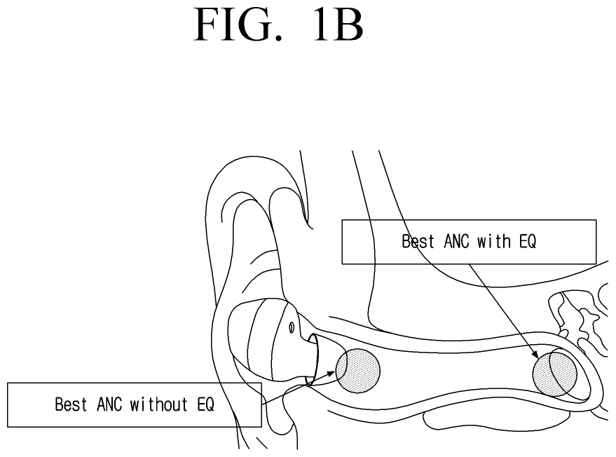

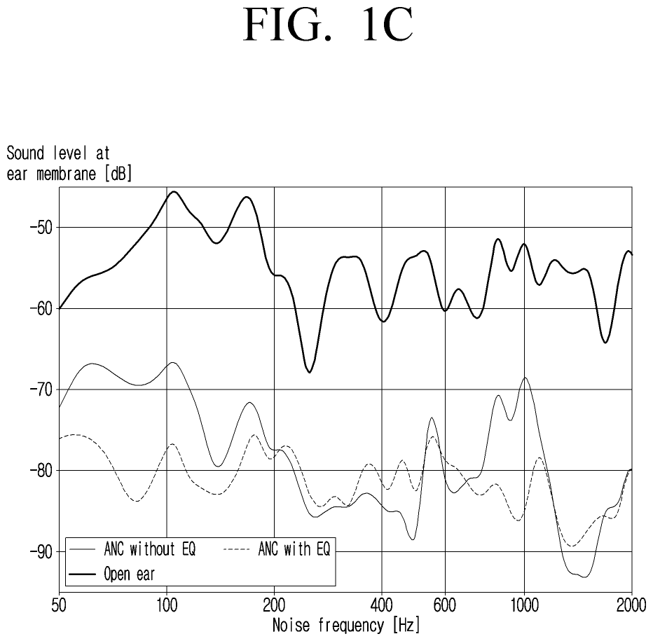

FIGS. 1A, 1B, and 1C are views provided to illustrate noise cancellation to help understanding according to various embodiments of the disclosure.

Referring to FIGS. 1A, 1B, and 1C, the electronic apparatus performing noise cancellation may include one speaker and two microphones. For example, the electronic apparatus may include a speaker that outputs sound Y(z) into the ear canal of a user wearing the electronic apparatus, an external microphone that receives external sound K(z), and an in-ear microphone that receives external sound L(z) and sound inside the ear canal of the user, as shown in FIG. 1A.

Here, a path for sound of the electronic apparatus may include a primary path and an auxiliary path. For example, the primary path is the transmittance between the external microphone and the in-ear microphone, which represents how the external sound changes as it enters the ear, and can be expressed as P(z)=L(z)/K(z). The auxiliary path is the transmittance between the speaker and the in-ear microphone, which can be expressed as S(z).

In a noise canceling algorithm, the auxiliary path is measured at initialization, and simulated within the noise canceling algorithm so that a response to a given output (S\hat{ }(z)) can be predicted. Through this, it is possible to use at least a partially adaptive internal model control (IMC) approach in a real-time simulated acoustic system.

The noise cancellation may include a computing operation of an in-ear signal through D(z)=P(z)X(z) and a computing operation of a speaker signal through Y(z)=D(z)/S(z). However, since S(z) has a longer delay time than P(z), Y(z) cannot be perfectly computed. This limitation may also affect the convergence of the adaptive filter used for estimation.

In other words, as shown in FIG. 1B, due to the gap between the in-ear microphone and the ear membrane, the performance of noise cancellation may be degraded. Therefore, equalization (EQ) is required. If there is no EQ work, the electronic apparatus becomes the reference location for noise cancellation, but if EQ work is added, the user's ear membrane can be the reference location for noise cancellation.

In this case, as shown in FIG. 1C, in both cases without EQ work and with EQ work, noise is reduced compared to the case where the electronic apparatus is not worn, and noise canceling performance may be improved when there is EQ work equalization is performed compared to when EQ work is not performed. In other words, the gap between the in-ear microphone and the ear membrane can be bridged through EQ work.

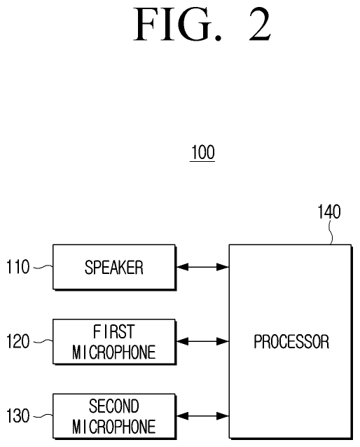

FIG. 2 is a block diagram illustrating configuration of an electronic apparatus according to an embodiment of the disclosure.

Referring to FIG. 2, the electronic apparatus 100 is a device worn by a user to output sound, which may be implemented as an earphone, a headset, or the like.

The user wearing the electronic apparatus 100 may hear sound output from the electronic apparatus 100 as well as external noise of the electronic apparatus 100. The electronic apparatus 100 may be a device with a noise cancellation function that removes external noise as noise.

The noise cancellation function be a technology that blocks or offsets external noise to help the user hear better without noise. For example, the noise cancellation function may include an active noise canceling (ANC) method, which cancels out external noise by generating a waveform that is opposite to the waveform of the external noise, and a passive noise canceling (PNC) method, which blocks out noise by physically covering ears.

The electronic apparatus 100 is worn by the user to output sound, and may be any device with the noise cancellation function.

Referring to FIG. 2, the electronic apparatus 100 includes a speaker 110, a first microphone 120, a second microphone 130, and a processor 140.

The speaker 110 is configured to output not only various audio data processed by the processor 140 but also various notification sound, voice messages, and the like. For example, the processor 140 may output signals of some of the channels included in the sound through the speaker 110.

The speaker 110 may be implemented as a plurality of speakers. For example, when the electronic apparatus 100 includes a first body and a second body, the speaker 110 may include a first speaker provided in the first body and a second speaker provided in the second body. However, the speaker 110 is not limited thereto, and the speaker 110 may be implemented in various ways.

The speaker 110 may be provided in a direction that can output sound from the electronic apparatus 100 to the ear membrane of the user. For example, when the electronic apparatus 100 is worn on the user's ear, the speaker 110 may be implemented to be positioned in a direction to output sound through the ear canal of the user and into the ear membrane. In other words, when the electronic apparatus 100 is worn by the user, the entrance to the ear canal of the user may be blocked by the electronic apparatus 100, and the sound output by the speaker 110 may be provided from the entrance to the ear canal to the ear membrane. Hereinafter, for convenience of explanation, after the electronic apparatus 100 is worn by the user, the configuration in which the electronic apparatus 100 is exposed to the outside of the electronic apparatus 100 is referred to as an embodiment of the electronic apparatus 100 being implemented in a first area, and the configuration in which the electronic apparatus 100 is provided in the direction of the entrance to the ear canal in the electronic apparatus 100 is referred to as an embodiment of the electronic apparatus 100 being implemented in a second area. In this case, the speaker 110 may be described as being implemented in the second area of the electronic apparatus 100.

Each of the first microphone 120 and the second microphone 130 is configured to receive sound input and convert it into an audio signal. Each of the first microphone 120 and the second microphone 130 is electrically connected to the processor 140, and may receive sound under the control of the processor 140.

For example, the first microphone 120 may be implemented in the first area of the electronic apparatus 100 to receive external noise of the electronic apparatus 100. The second microphone 130 may be implemented in the second area of the electronic apparatus 100 to receive sound which is output through the speaker 110 and reflected from the ear canal, ear membrane, and the like.

Each of the first microphone 120 and the second microphone 130 may include various components, such as a microphone that collects sound in an analog form, an amplification circuit that amplifies the collected sound, an analog-to-digital (A/D) conversion circuit that samples the amplified sound and converts it into a digital signal, a filter circuit that removes noise components from the converted digital signal, or the like.

Meanwhile, each of the first microphone 120 and the second microphone 130 may be implemented in the form of a sound sensor, and may be configured in any form as long as it can collect sound.

The processor 140 controls the overall operations the electronic apparatus 100. Specifically, the processor 140 may be connected to each configuration of the electronic apparatus 100 to control the overall operations of the electronic apparatus 100. For example, the processor 140 may be connected to configurations, such as the speaker 110, the communication interface 150, the memory (not shown), and the like to control the operations of the electronic apparatus 100.

The one or more processors 140 may include one or more of a central processing unit (CPU), a graphics processing unit (GPU), an accelerated processing unit (APU), a many integrated core (MIC), a neural processing unit (NPU), a hardware accelerator, or a machine learning accelerator. The one or more processors 140 may control one or any combination of the other components of the electronic apparatus 100, and may perform communication-related operations or data processing. The one or more processors 140 may execute one or more programs or instructions stored in memory. For example, the one or more processors 140 may perform a method according to an embodiment by executing one or more instructions stored in the memory.

When a method according to an embodiment includes a plurality of operations, the plurality of operations may be performed by one processor or by a plurality of processors. For example, when a first operation, a second operation, and a third operation are performed by the method according to an embodiment of the disclosure, all of the first operation, the second operation, and the third operation may be performed by the first processor, or the first operation and the second operation may be performed by the first processor (e.g., a general-purpose processor) and the third operation may be performed by the second processor (e.g., an artificial intelligence-dedicated processor).

The one or more processors 140 may be implemented as a single core processor comprising a single core, or as one or more multicore processors including a plurality of cores (e.g., homogeneous multicore or heterogeneous multicore). When the one or more processors 140 are implemented as multicore processors, each of the plurality of cores included in a multicore processor may include a processor internal memory, such as cache memory and on-chip memory, and a common cache shared by the plurality of cores may be included in the multicore processor. Further, each of the plurality of cores (or some of the plurality of cores) included in the multi-core processor may independently read and perform program instructions to implement the method according to an embodiment of the disclosure, or all (or some) of the plurality of cores may be coupled to read and perform program instructions to implement the method according to an embodiment.

When a method according to an embodiment includes a plurality of operations, the plurality of operations may be performed by one core of a plurality of cores included in a multi-core processor, or may be performed by a plurality of cores. For example, when a first operation, a second operation, and a third operation are performed by a method according to an embodiment of the disclosure, all of the first operation, the second operation, and the third operation may be performed by the first core included in the multi-core processor, or the first operation and the second operation may be performed by the first core included in the multi-core processor and the third operation may be performed by the second core included in the multi-core processor.

In the embodiments of the disclosure, the one or more processors 140 may mean a system-on-chip (SoC) in which one or more processors and other electronic components are integrated, a single-core processor, a multi-core processor, or a core included in a single-core processor or multi-core processor. Here, the core may be implemented as CPU, GPU, APU, MIC, NPU, hardware accelerator, or machine learning accelerator, or the like, but the core is not limited to the embodiments of the disclosure. However, hereinafter, for convenience of explanation, the operation of the electronic apparatus 100 will be described using the term ‘processor 140.’

Firstly, the method of obtaining a target phase and a target gain for performing noise cancellation with reference to the user's ear membrane will be described and then, the method of noise-cancelling external sound with the target phase and the target gain will be described.

The processor 140 may control an external speaker to output sound of a first frequency. For example, the electronic apparatus 100 may further include a communication interface, and the processor 140 may control the communication interface to transmit a control signal that controls to output the sound of the first frequency to the external speaker. Here, the sound of the first frequency can be viewed as external sound.

The processor 140 may obtain a first sound signal corresponding to the sound of the first frequency through the first microphone 120 and a second sound signal including the first sound signal through the second microphone 130. Here, the second sound signal includes not only the first sound signal but also a signal obtained through the operation described hereinafter, which will be described after further describing the operation of the processor 140.

The processor 140 may obtain a first noise canceling signal based on the first sound signal and the second sound signal. For example, the processor 140 may obtain an inverse phase signal of a signal including the first sound signal and the second sound signal as the first noise canceling signal. For example, the processor 140 may obtain an inverse phase signal of a signal including the first sound signal and the second sound signal in a feed forward active noise canceling (ANC) manner as the first noise cancelling signal.

The processor 140 may output a second noise canceling signal in which at least one of the phase or the gain of the first noise canceling signal is changed, and a third sound signal of a second frequency through the speaker 110. The sound output through the speaker 110 may be received through the second microphone 130. Accordingly, the processor 140 may receive the first sound signal, the second noise cancelling signal, the third sound signal, and a signal including a sound signal corresponding to a third frequency component as the second sound signal. Here, the third frequency component is a frequency component related to distortion product otoacoustic emissions (DPOAE), wherein the distortion product otoacoustic emissions (DPOAE) means that sound of two frequencies generate various distortion sound different from the two frequencies in the outer hair cells of the cochlea, and the third frequency component may be the component with the strongest intensity among the modulated components. In the above-described example, the sound of the first frequency of f1 and the sound of the second frequency of f2 may be modulated in the outer hair cells of the cochlea, and the third frequency component with the strongest intensity among the modulated frequency components may be the frequency of 2f1-f2. Here, f2 may be 1.2f1.

The processor 140 may obtain the second sound signal by changing at least one of the phase or the gain, and may identify at least one of a target phase or a target gain based on the third frequency component related to the distortion product otoacoustic emissions (DPOAE) of the first frequency and the second frequency included in the second sound signal. In other words, when at least one of the phase or the gain is changed, the second noise canceling signal is changed, when the second noise canceling signal is changed, the sound output through the speaker 110 is changed, when the sound output through the speaker 110 is changed, the second sound signal obtained through the second microphone 130 is changed, and accordingly, the third frequency component included in the second sound signal may be changed. The processor 140 may repeatedly change at least one of the phase or the gain, and obtain the changed third frequency component to identify at least one of the target phase or target gain.

For example, the processor 140 may gradually change the phase to identify a phase section in which the distortion product otoacoustic emissions (DPOAE) does not occur, and identify the target phase based on the phase section. For example, the processor 140 may identify the center of the phase section as the target phase. The absence of the distortion product otoacoustic emissions (DPOAE) indicates that maximum attenuation occurred in the ear membrane, which means that the external sound was maximally attenuated in the ear membrane.

When the gain is 0, the processor 140 may change the amplitude of the sound of the first frequency to identify a minimum amplitude at which the distortion product otoacoustic emissions (DPOAE) occurs, and may identify the target gain based on the minimum amplitude. For example, the processor 140 may identify a half value of the minimum amplitude as the amplitude of the sound of the first frequency, change the gain when the amplitude of the sound of the first frequency is the half value of the minimum amplitude to identify a minimum gain at which the distortion product otoacoustic emissions (DPOAE) occurs, and identify the minimum gain as the target gain.

As described above, the processor 140 may identify a minimum phase and a minimum gain based on the first frequency. However, the identified minimum phase and minimum gain are for the first frequency, and noise canceling performance may be degraded at frequencies other than the first frequency.

Accordingly, the processor 140 may change the first frequency and the second frequency, and may repeatedly perform the target phase identification operation and the target gain identification operation. The processor 140 may map a plurality of target phases and a plurality of target gains obtained by the repetitive operation to the corresponding first frequency and second frequency and store the same in memory.

The above describes the method for obtaining a plurality of target phases and a plurality of target gains for performing noise canceling based on a user's ear membrane. The following describes a method for noise canceling an external sound after the plurality of target phases and the plurality of target gains are stored in memory.

The processor 140 may obtain an external sound signal corresponding to external sound through the first microphone 120, obtain a fourth sound signal including the external sound signal through the second microphone 130, obtain a third noise cancelling signal by performing active noise-cancelling on the external sound signal and the fourth sound signal, and output, through the speaker 110, a fourth noise cancelling signal in which that phase and gain of the third noise cancelling signal are changed based on the target phase and the target gain corresponding to the frequency of the external sound among information stored in the memory. This operation can increase the canceling effect of the external sound.

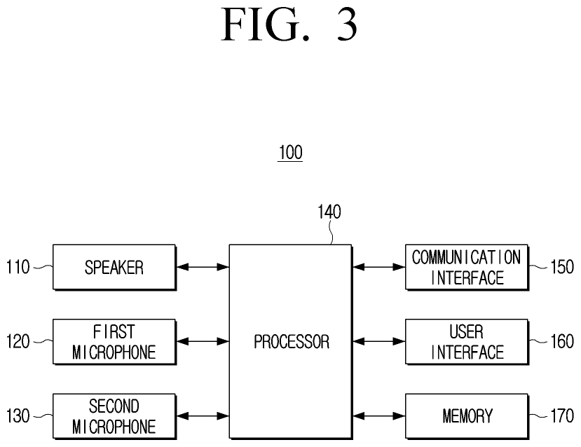

FIG. 3 is a block diagram illustrating a configuration of an electronic apparatus according to an embodiment of the disclosure.

Referring to FIG. 3, the electronic apparatus 100 may include the speaker 110, the first microphone 120, the second microphone 130, and the processor 140. Referring to FIG. 3, the electronic apparatus 100 may further include a communication interface 150, a user interface 160, and memory 170. The components shown in FIG. 3 that overlap with the components shown in FIG. 2 will not be described in detail.

The communication interface 150 is configured to perform communication with various types of external devices according to various types of communication methods. For example, the electronic apparatus 100 may perform communication with an external speaker through the communication interface 150.

The communication interface 150 may include a wireless fidelity (Wi-Fi) module, a Bluetooth module, an infrared communication module, a wireless communication module, and the like. Here, each communication module may be implemented in the form of at least one hardware chip.

The Wi-Fi module and the Bluetooth module perform communication using a Wi-Fi method and a Bluetooth method, respectively. When using a Wi-Fi module or a Bluetooth module, various connection information, such as service set identifier (SSID) and session keys are first transmitted and received, and various information can be transmitted and received after establishing a communication connection using the same. The infrared communication module performs communication according to an infrared Data Association (IrDA) communication technology which transmits data wirelessly over a short distance using infrared rays between optical light and millimeter waves.

The wireless communication module may include at least one communication chip that performs communication according to various wireless communication standards, such as Zigbee, 3^{rd} generation (3G), 3^{rd} generation partnership project (3GPP), long term evolution (LTE), LTE advanced (LTE-A), 4^{th} generation (4G), 5^{th} generation (5G), or the like.

Alternatively, the communication interface 150 may include a wired communication interface, such as high definition multimedia interface (HDMI), DisplayPort, Thunderbolt, USB, red green blue (RGB), D-subminiature (D-SUB), digital visual interface (DVI), or the like.

In addition, the communication interface 150 may include at least one of a local area network (LAN) module, an Ethernet module, or a wired communication module that performs communication using pair cables, coaxial cables, fiber optic cables, or the like.

The user interface 160 may be implemented as a button, a touch pad, a mouse, a keyboard, or the like, or may be implemented as a touch screen that can also perform a display function and a manipulation input function. Here, the button may be various types of buttons, such as a mechanical button, a touch pad, a wheel, or the like, formed in any arbitrary area of the exterior of the main body of the electronic apparatus 100, such as the front, side, or back.

The memory 170 may refer to hardware that stores information, such as data, in electrical or magnetic form for access by the processor 140 or the like. To this end, the memory 170 may be implemented as at least one of the following hardware: non-volatile memory, volatile memory, flash memory, hard disk drive (HDD) or solid state drive (SSD), random access memory (RAM), read only memory (ROM), or the like.

The memory 170 may store at least one instruction required for the operation of the electronic apparatus 100 or the processor 140. Here, the instruction is a code unit that directs the operation of the electronic apparatus 100 or processor 140, and may be written in a machine language that can be understood by a computer. Alternatively, the memory 170 may store a plurality of instructions for performing specific tasks of the electronic apparatus 100 or the processor 140 as an instruction set.

The memory 170 may store data, which is information in bits or bytes that may represent characters, numbers, images, and the like. For example, the memory 170 may store a module related to the target phase and the target gain.

The memory 170 is accessed by the processor 140, and reading/writing/modifying/deleting/updating instructions, a set of instructions, or data may be performed by the processor 140.

As described above, the electronic apparatus 100 may perform noise canceling with the user's ear membrane as a reference location to improve noise canceling performance.

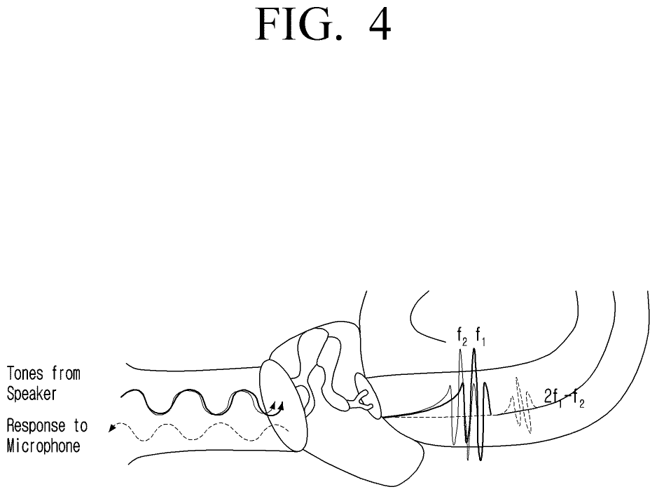

Hereinafter, the operation of the electronic apparatus 100 will be described with reference to FIGS. 4 to 12. For convenience of explanation, individual embodiments will be described in FIGS. 4 to 12. However, the individual embodiments of FIGS. 4 to 12 may be practiced in any combination.

FIG. 4 is a view provided to illustrate distortion product otoacoustic emissions (DPOAE) according to an embodiment of the disclosure.

Referring to FIG. 4, the distortion product otoacoustic emissions (DPOAE) is when stimulation sound which is a pure tone with two different frequencies, is applied simultaneously, distortion sound of several frequencies different from the two different frequencies is generated from the outer hair cells of the cochlea.

For example, as shown in FIG. 4, when sound of a first frequency of f1 and sound of a second frequency of f2 are applied, they may be modulated in the outer hair cells of the cochlea to generate distortion sound including various frequencies, such as f2-f1, 2f1-f2, 2f2-f1, and the like, and the frequency component of 2f1-f2 with the strongest intensity among the modulated frequency components may be used for clinical examination. Here, f2 may be set to 1.2f1.

Accordingly, it may mean that the smaller the amplitude of the third frequency component of 2f1-f2 related to the distortion product otoacoustic emissions (DPOAE), the sound of the first frequency of f1 is maximally attenuated from the entrance to the ear canal until it reaches the ear membrane. As the amplitude of the third frequency component of 2f1-f2 is lowered through the method described in FIG. 2, the effect of noise canceling of external sound can increase.

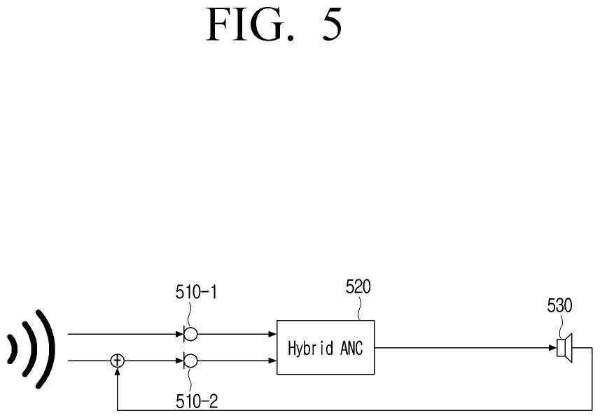

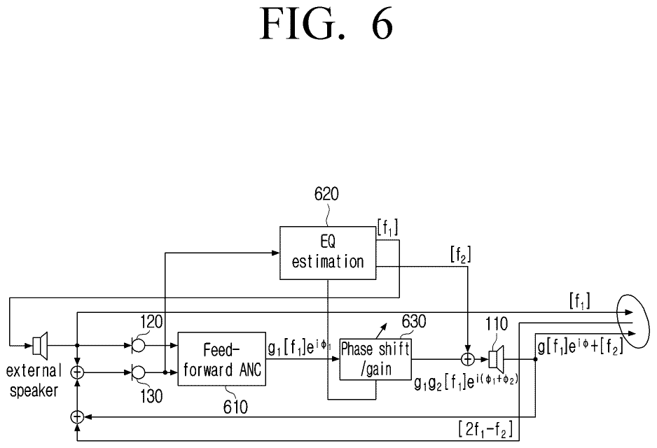

FIGS. 5 and 6 are views provided to illustrate noise cancellation according to various embodiments of the disclosure.

Referring to FIG. 5, the existing earphone uses the method of performing hybrid active noise cancellation 520 on sound received from an external microphone 510-1 and sound received from an in-ear microphone 510-2 and outputting the same through the speaker 530. In this case, the noise canceling is performed with reference to the earphone and thus, noise may not be removed completely in the user's ear membrane.

To perform noise canceling with reference to the user's ear membrane, the processor 140 may change at least one of the phase or the gain of the noise canceling signal to perform noise canceling with reference to the user's ear membrane. However, the phase or the gain may not be specified since different users may have different ear canal shapes, or the like.

Referring to FIG. 6, the processor 140 may control an external speaker to output the sound of the first frequency of f1 through an equalization (EQ) module 620, obtain the first sound signal corresponding to the sound of the first frequency through the first microphone 120, and obtain the second sound signal including the first sound signal through the second microphone 130.

The processor 140 may obtain the first noise canceling signal from the first sound signal and the second sound signal through a feed forward active noise canceling scheme 610. The first noise canceling signal may be a signal having an amplitude of g1, a first frequency of f1, and a phase of φ1.

The processor 140 may change at least one of the phase or the gain of the first noise canceling signal through a phase shift/gain 630 to obtain the second noise canceling signal, and output the second noise canceling signal and the third sound signal of the second frequency through the speaker 110. The second noise canceling signal may be a signal having an amplitude of g1g2, a first frequency of f1, and a phase of φ1+φ2, and the sound output through the speaker 110 may include a signal having an amplitude of g, a first frequency of f1, a phase of φ, and a second frequency of f2.

In this case, the first sound having the first frequency of f1 and the sound output through the speaker 110 are applied to the user's ear membrane, and distortion sound including various frequencies according to the distortion product otoacoustic emissions (DPOAE) may be generated therefrom.

The second microphone 130 may receive not only the first sound having the first frequency of f1 and the sound output through the speaker 110 but also the sound subject to the distortion product otoacoustic emissions (DPOAE), and the processor 140 may identify the magnitude of the frequency component of 2f1-f2 that has the strongest intensity among the modulated frequency components.

The processor 140 may identify the magnitude of the frequency component of 2f1-f2 by changing at least one of the phase or the gain, and may identify the target phase and the target gain with the highest noise canceling performance based on the magnitude of the frequency component of 2f1-f2.

In addition, the processor 140 may repeatedly perform the target phase identification operation and the target gain identification operation by changing the first frequency and the second frequency as described above.

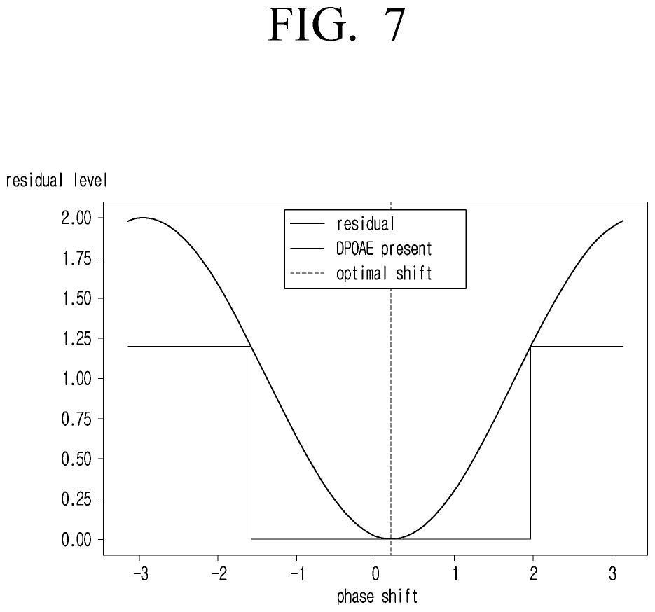

FIG. 7 is a view provided to illustrate a method of identifying a target phase according to an embodiment of the disclosure.

Referring to FIG. 7, the processor 140 may gradually change the phase to identify a phase section in which the distortion product otoacoustic emissions (DPOAE) does not occur, and identify the target phase based on the phase section.

For example, as shown in FIG. 7, the processor 140 may gradually change the phase from −3.5 to 3.5 to identify the phase section of −1.6 to 2 in which the distortion product otoacoustic emissions (DPOAE) does not occur, and identify the center of the phase section, 0.2, as the target phase.

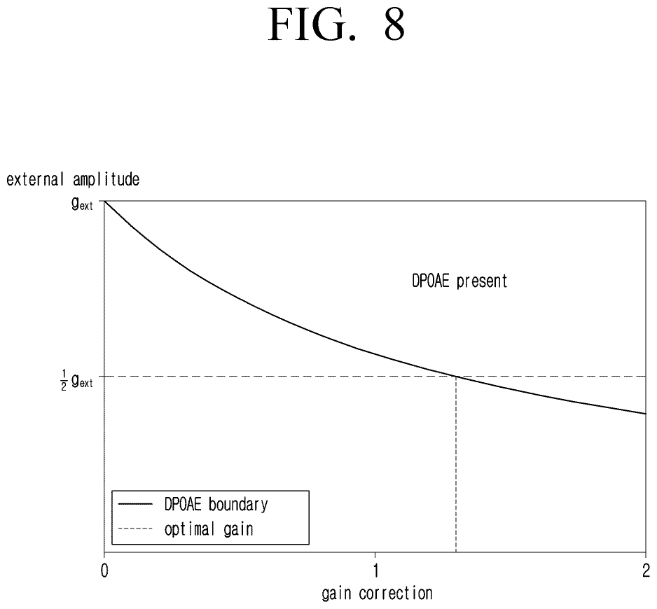

FIG. 8 is a view provided to illustrate a method of identifying a target gain according to an embodiment of the disclosure.

Referring to FIG. 8, when the gain is 0, the processor 140 may change the amplitude of the sound of the first frequency to identify a minimum amplitude at which the distortion product otoacoustic emissions (DPOAE) occurs, and identify the target gain based on the minimum amplitude.

For example, as shown in FIG. 8, when the gain is 0, the processor 140 may change the amplitude of the sound of the first frequency to identify a minimum amplitude GEXT at which the distortion product otoacoustic emissions (DPOAE) occurs, identify GEXT/2, which is the half value of the minimum amplitude, as the amplitude of the sound of the first frequency, and when the amplitude of the sound of the first frequency is GEXT/2, change the gain to identify a minimum gain of 1.3 at which the distortion product otoacoustic emissions (DPOAE) occurs, and identify the minimum gain of 1.3 as the target gain.

However, the disclosure is not limited thereto, and the target gain may be identified through various methods that take into account whether the distortion product otoacoustic emissions (DPOAE) occurs.

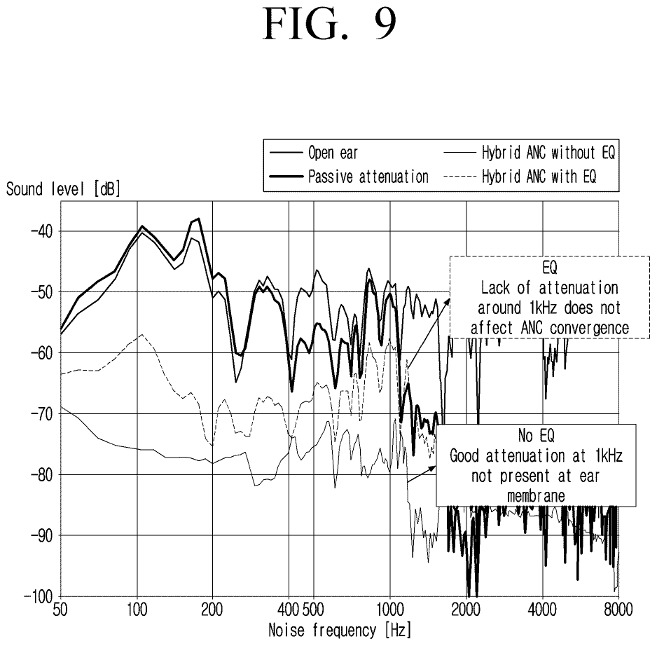

FIGS. 9, 10, 11, and 12 are views provided to illustrate an effect of noise cancellation according to various embodiments of the disclosure.

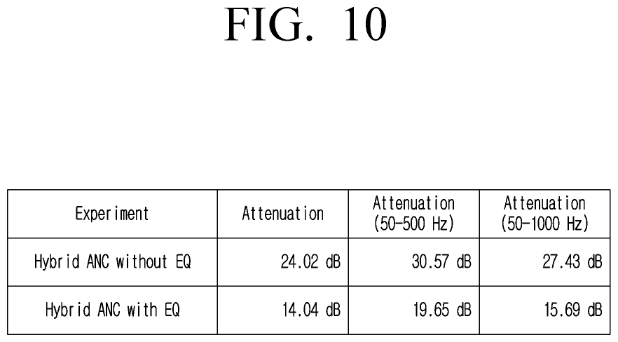

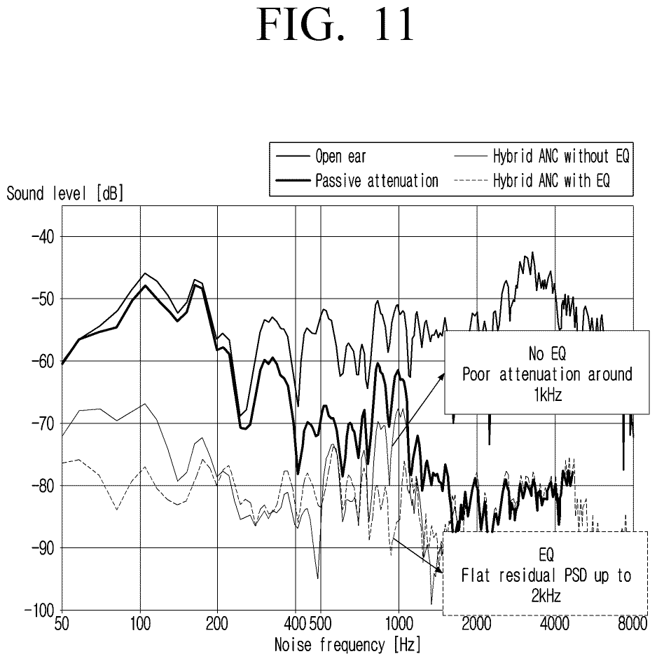

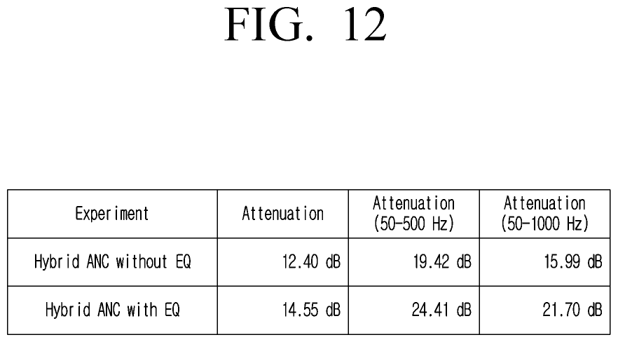

FIGS. 9 and 10 show the attenuation in the second microphone, and FIGS. 11 and 12 show the attenuation in the user's ear membrane.

Comparing FIGS. 9 and 11, it can be seen that when an EQ operation that changes at least one of the phase or the gain of the disclosure is added, the attenuation characteristics in the ear membrane are improved.

In addition, comparing FIGS. 10 and 12, it can be seen that when an equalization operation that changes at least one of the phase or the gain of the present initiator is added, the attenuation value is the highest.

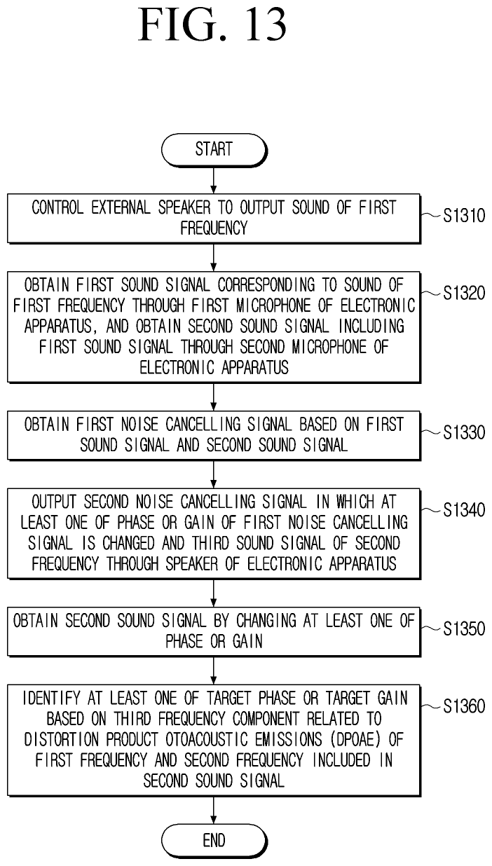

FIG. 13 is a flowchart provided to illustrate a method of controlling an electronic apparatus according to an embodiment of the disclosure.

Referring to FIG. 13, an external speaker is controlled to output a sound of a first frequency at operation S1310. A first sound signal corresponding to the sound of the first frequency is obtained through a first microphone of the electronic apparatus at operation S1320. A second sound signal including the first sound signal is obtained through a second microphone of the electronic apparatus at operation S1330. A first noise canceling signal is obtained based on the first sound signal and the second sound signal at operation S1340. A second noise canceling signal in which at least one of the phase or the gain of the first noise cancelling signal is changed and a third sound signal of a second frequency are output through a speaker of the electronic apparatus at operation S1350. The second sound signal is obtained by changing at least one of the phase or the gain, and at least one of a target phase or a target gain is identified based on a third frequency component related to the distortion product otoacoustic emissions (DPOAE) of the first frequency and the second frequency included in the second sound signal at operation S1360.

In addition, the identifying operation S1360 may include gradually changing the phase to identify a phase section in which the distortion product otoacoustic emissions (DPOAE) does not occur, and identifying the target phase based on the phase section.

Subsequently, the identifying operation S1360 may include identifying the center of the phase section as the target phase.

In addition, the identifying operation S1360 may include, when the gain is 0, changing the amplitude of the sound of the first frequency to identify a minimum amplitude at which the distortion product otoacoustic emissions (DPOAE) occurs, and identifying the target gain based on the minimum amplitude.

In addition, the identifying operation S1360 may include identifying the half value of the minimum amplitude as the amplitude of the sound of the first frequency, identify a minimum gain at which the distortion product otoacoustic emissions (DPOAE) occurs by changing the gain when the amplitude of the sound of the first frequency is half the value of the minimum amplitude, and identify the minimum gain as the target gain.

The method may further include changing the first frequency and the second frequency, repeating the target phase identification operation and the target gain identification operation, and mapping a plurality of target phases and a plurality of target gains obtained according to the repetitive operation to corresponding first frequency and second frequency and storing the same in memory of the electronic apparatus.

The method may further include obtaining an external sound signal corresponding to external sound through the first microphone, obtaining a fourth sound signal including the external sound signal through the second microphone, obtaining a third noise cancelling signal by performing active noise-cancelling on the external sound signal and the fourth sound signal, and outputting a fourth noise cancelling signal in which the phase and gain of the third noise cancelling signal are changed based on the target phase and the target gain corresponding to the frequency of the external sound among information stored in the memory through a speaker.

In addition, the controlling operation S1310 may include transmitting a control signal that controls to output the sound of the first frequency to an external speaker.

Subsequently, the step of obtaining the first sound signal and the second sound signal at operation S1320 may include receiving the first sound signal, the second noise cancelling signal, the third sound signal, and the second sound signal including a sound signal corresponding to a third frequency component through the second microphone.

In addition, the step of obtaining the first noise cancelling signal at operation S1330 may include obtaining an inverse phase signal including the first sound signal and the second sound signal as the first noise cancelling signal.

According to the above-described various embodiments of the disclosure, the electronic apparatus may perform noise canceling with the user's ear membrane as a reference location to improve noise canceling performance.

Meanwhile, according to an embodiment of the disclosure, the above-described various embodiments may be implemented as software including instructions stored in machine-readable storage media, which can be read by machine (e.g.: computer). The machine refers to a device that calls instructions stored in a storage medium, and can operate according to the called instructions, and the device may include an electronic apparatus (e.g., electronic apparatus (A)) according to the aforementioned embodiments. In case an instruction is executed by a processor, the processor may perform a function corresponding to the instruction by itself, or by using other components under its control. An instruction may include a code that is generated or executed by a compiler or an interpreter. The machine-readable storage medium may be provided in a form of a non-transitory storage medium. Here, the term “non-transitory” means that the storage medium is tangible without including a signal, and does not distinguish whether data are semi-permanently or temporarily stored in the storage medium.

In addition, according to an embodiment of the disclosure, the above-described methods according to the various embodiments may be included and provided in a computer program product. The computer program product may be traded as a product between a seller and a purchaser. The computer program product may be distributed in a form of a storage medium (for example, compact disc read only memory (CD-ROM)) that may be read by the machine or online through an application store (for example, PlayStore™). In case of the online distribution, at least a portion of the computer program product may be at least temporarily stored in a storage medium, such as memory of a server of a manufacturer, a server of an application store, or a relay server or be temporarily generated.

Further, according to an embodiment of the disclosure, the above-described various embodiments may be implemented in a recording medium that can be read by a computer or a similar device using software, hardware, or a combination thereof. In some cases, embodiments described herein may be implemented by a processor itself. According to software implementation, embodiments, such as procedures and functions described in this specification may be implemented as separate software. Each software may perform one or more functions and operations described in this disclosure.

Meanwhile, computer instructions for performing processing operations of the electronic apparatus according to the above-described various embodiments may be stored in a non-transitory computer-readable medium. When being executed by a processor of a specific device, the computer instructions stored in such a non-transitory computer-readable medium allows the specific device to perform processing operations in a device according to the above-described various embodiments. The non-transitory computer-readable medium refers to a medium that stores data semi-permanently and can be read by a device, rather than a medium that stores data for a short period of time, such as registers, caches, memory, or the like. Specific examples of the non-transitory computer-readable medium may include compact disc (CD), digital versatile discs (DVD), hard disk, Blu-ray disk, USB, memory card, ROM, or the like.

In addition, the components (for example, modules or programs) according to various embodiments described above may include a single entity or a plurality of entities, and some of the corresponding sub-components described above may be omitted or other sub-components may be further included in the various embodiments. Alternatively or additionally, some components (e.g., modules or programs) may be integrated into one entity and perform the same or similar functions performed by each corresponding component prior to integration. Operations performed by the modules, the programs, or the other components according to the diverse embodiments may be executed in a sequential manner, a parallel manner, an iterative manner, or a heuristic manner, or at least some of the operations may be performed in a different order or be omitted, or other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic apparatus comprising:
a speaker;
a first microphone;
a second microphone;
memory storing one or more computer programs; and
one or more processors communicatively coupled to the speaker, the first microphone, the second microphone, and the memory,
wherein the one or more computer programs include computer-executable instructions that, when executed by the one or more processors individually or collectively, cause the electronic apparatus to:
control an external speaker to output sound of a first frequency,
obtain a first sound signal corresponding to the sound of the first frequency through the first microphone, and obtain a second sound signal including the first sound signal through the second microphone,
obtain a first noise cancelling signal based on the first sound signal and the second sound signal,
output a second noise cancelling signal in which at least one of a phase or a gain of the first noise cancelling signal is changed and a third sound signal of a second frequency through the speaker,
obtain the second sound signal by changing at least one of the phase or the gain, and
identify at least one of a target phase or a target gain based on a third frequency component related to distortion product otoacoustic emissions (DPOAE) of the first frequency and the second frequency included in the second sound signal.

2. The apparatus of claim 1, wherein the one or more computer programs further include computer-executable instructions that, when executed by the one or more processors individually or collectively, cause the electronic apparatus to:
identify a phase section in which the phase is gradually changed such that the distortion product otoacoustic emissions (DPOAE) does not occur, and
identify the target phase based on the phase section.

3. The apparatus of claim 2, wherein the one or more computer programs further include computer-executable instructions that, when executed by the one or more processors individually or collectively, cause the electronic apparatus to identify a center of the phase section as the target phase.

4. The apparatus of claim 2, wherein the one or more computer programs further include computer-executable instructions that, when executed by the one or more processors individually or collectively, cause the electronic apparatus to:
based on the gain being 0, identify a minimum amplitude at which the distortion product otoacoustic emissions (DPOAE) occurs by changing an amplitude of the sound of the first frequency, and
identify the target gain based on the minimum amplitude.

5. The apparatus of claim 4, wherein the one or more computer programs further include computer-executable instructions that, when executed by the one or more processors individually or collectively, cause the electronic apparatus to:
identify a half value of the minimum amplitude as an amplitude of the sound of the first frequency,
based on the amplitude of the sound of the first frequency being the half value of the minimum amplitude, identify a minimum gain in which the distortion product otoacoustic emissions (DPOAE) occurs by changing the gain, and
identify the minimum gain as the target gain.

6. The apparatus of claim 5, wherein the one or more computer programs further include computer-executable instructions that, when executed by the one or more processors individually or collectively, cause the electronic apparatus to:
change the first frequency and the second frequency, and repeat target phase identification operation and the target gain identification operation, and
map a plurality of target phases and a plurality of target gains obtained through the repetitive operation to corresponding first frequency and second frequency and store the same in the memory.

7. The apparatus of claim 6, wherein the one or more computer programs further include computer-executable instructions that, when executed by the one or more processors individually or collectively, cause the electronic apparatus to:
obtain an external sound signal corresponding to external sound through the first microphone, and obtain a fourth sound signal including the external sound signal through the second microphone,
obtain a third noise cancelling signal by cancelling active noise from the external sound signal and the fourth sound signal, and
output a fourth noise cancelling signal in which a phase and a gain of the third noise cancelling signal are changed based on a target phase and a target gain corresponding to a frequency of the external sound among information stored in the memory.

8. The apparatus of claim 1, further comprising:
a communication interface,
wherein the one or more computer programs further include computer-executable instructions that, when executed by the one or more processors individually or collectively, cause the electronic apparatus to control the communication interface to transmit a control signal to output the sound of the first frequency to the external speaker.

9. The apparatus of claim 1, wherein the one or more computer programs further include computer-executable instructions that, when executed by the one or more processors individually or collectively, cause the electronic apparatus to receive the first sound signal, the second noise cancelling signal, the third sound signal, and the second sound signal including a sound signal corresponding to the third frequency component through the second microphone.

10. The apparatus of claim 1, wherein the one or more computer programs further include computer-executable instructions that, when executed by the one or more processors individually or collectively, cause the electronic apparatus to obtain an inverse phase signal of a signal including the first sound signal and the second sound signal as the first noise cancelling signal.

11. A method of controlling an electronic apparatus, the method comprising:
controlling an external speaker to output sound of a first frequency;
obtaining a first sound signal corresponding to the sound of the first frequency through a first microphone of the electronic apparatus, and obtaining a second sound signal including the first sound signal through a second microphone of the electronic apparatus;
obtaining a first noise cancelling signal based on the first sound signal and the second sound signal;
outputting a second noise cancelling signal in which at least one of a phase or a gain of the first noise cancelling signal is changed and a third sound signal of a second frequency through a speaker of the electronic apparatus;
obtaining the second sound signal by changing at least one of the phase or the gain; and
identifying at least one of a target phase or a target gain based on a third frequency component related to distortion product otoacoustic emissions (DPOAE) of the first frequency and the second frequency included in the second sound signal.

12. The method of claim 11, wherein the identifying comprises:
identifying a phase section in which the phase is gradually changed such that the distortion product otoacoustic emissions (DPOAE) does not occur; and
identifying the target phase based on the phase section.

13. The method of claim 12, wherein the identifying comprises identifying a center of the phase section as the target phase.

14. The method of claim 12, wherein the identifying comprises:
based on the gain being 0, identifying a minimum amplitude at which the distortion product otoacoustic emissions (DPOAE) occurs by changing an amplitude of the sound of the first frequency; and
identifying the target gain based on the minimum amplitude.

15. The method of claim 14, wherein the identifying comprises:
identifying a half value of the minimum amplitude as an amplitude of the sound of the first frequency;
based on the amplitude of the sound of the first frequency being the half value of the minimum amplitude, identifying a minimum gain in which the distortion product otoacoustic emissions (DPOAE) occurs by changing the gain; and
identifying the minimum gain as the target gain.

16. The method of claim 15, further comprising:
changing the first frequency and the second frequency, and repeat target phase identification operation and the target gain identification operation; and
mapping a plurality of target phases and a plurality of target gains obtained through the repetitive operation to corresponding first frequency and second frequency and store the same in memory.

17. The method of claim 16, further comprising:
obtaining an external sound signal corresponding to external sound through the first microphone, and obtain a fourth sound signal including the external sound signal through the second microphone;
obtaining a third noise cancelling signal by cancelling active noise from the external sound signal and the fourth sound signal; and
outputting a fourth noise cancelling signal in which a phase and a gain of the third noise cancelling signal are changed based on a target phase and a target gain corresponding to a frequency of the external sound among information stored in the memory.

18. The method of claim 11, further comprising:
controlling a communication interface to transmit a control signal to output the sound of the first frequency to the external speaker.

19. One or more non-transitory computer-readable storage media storing computer-executable instructions that, when executed by one or more processors individually or collectively, cause an electronic apparatus to perform operations, the operations comprising:
controlling an external speaker to output sound of a first frequency;
obtaining a first sound signal corresponding to the sound of the first frequency through a first microphone of the electronic apparatus, and obtaining a second sound signal including the first sound signal through a second microphone of the electronic apparatus;
obtaining a first noise cancelling signal based on the first sound signal and the second sound signal;
outputting a second noise cancelling signal in which at least one of a phase or a gain of the first noise cancelling signal is changed and a third sound signal of a second frequency through a speaker of the electronic apparatus;
obtaining the second sound signal by changing at least one of the phase or the gain; and
identifying at least one of a target phase or a target gain based on a third frequency component related to distortion product otoacoustic emissions (DPOAE) of the first frequency and the second frequency included in the second sound signal.

20. The one or more non-transitory computer-readable storage media of claim 19, the operations further comprising:
identifying a phase section in which the phase is gradually changed such that the distortion product otoacoustic emissions (DPOAE) does not occur; and
identifying the target phase based on the phase section.
